(19) United States
(12) Patent Application Publication
(10) Pub. No.: US 2026/0182616 A1
(43) Pub. Date: Jul. 2, 2026

(54) MANUFACTURING METHOD FOR READY-TO-EAT TAPIOCA BALL AND STRUCTURE THEREOF

(71) Applicant: SAN SHU GONG FOOD CO., LTD., New Taipei City (TW)

(72) Inventor: Mei-Yao Chen, New Taipei City (TW)

(21) Appl. No.: 19/004,476

(22) Filed: Dec. 30, 2024

(51) Int. Cl. A23P 30/20; A23L 7/126; A23L 29/212; A23L 29/30

(52) U.S. Cl. CPC A23P 30/20; A23L 7/126; A23L 29/212; A23L 29/30

(57) ABSTRACT

Disclosed are a method for manufacturing a ready-to-eat tapioca ball and a structure thereof. Materials, such as glutinous rice flour, modified starch, water, and maltose, are mixed with granulated sugar, brown sugar, matcha, or fruit additives of strawberry, mango, and pineapple, and are steamed and cooked to form a viscose base material, which is extruded by a forming apparatus into a round bar-shaped blank having an appropriate diameter. The round bar-shaped blank is cut into a segmented blank of an appropriate size, and the segmented blank is then kneaded into a spherical tapioca ball semi-finished product, while during the processes of cutting and kneading, the tapioca ball semi-finished product is coated with powder to thereby form tapioca balls of different flavors. The tapioca balls can be manufactured in a faster way and are ready to eat and can be used to conveniently make various tapioca ball-based drinks.

### BACKGROUND OF THE INVENTION

### (a) Technical Field of the Invention

The present invention relates to a manufacturing method for ready-to-eat tapioca balls and a structure thereof, and more particularly to a manufacturing method for tapioca balls that are produced in a faster way and are ready to eat and can be easily made into various pearl or tapioca ball drinks.

### (b) Description of the Prior Art

In recent years, franchising hand-shaking beverage industry in Taiwan has become quite developed and very popular with consumers. In particular, bubble milk tea is a best-seller and popular all over the world. The ingredients of the bubble milk tea mainly include tapioca balls or pearls, milk tea (or matcha, fruit tea and other tea drinks), and sugar water. The traditional way of manufacturing tapioca balls is to first make raw tapioca balls and then boil them with water for a certain period of time to become cooked tapioca balls, which are then cooled with ice water to become edible and chewy cooked tapioca balls. However, it is not easy to cook chewy and delicious tapioca balls. During the production process, some manufacturers may simply make undercooked tapioca balls due to poor time control or other variables, making them unable to cater to the taste of the consumers and consequently, the sales of products are affected. Therefore, how to carry out automatic production under standard processes to maintain a certain and consistent quality of the tapioca balls is desperately desired in the industry.

It is quite challenging in the course for realizing the fully automated production of tapioca balls. This is because the ingredients of the tapioca balls tend to stick together when they stay in the same position for a long time, and this results in multiple tapioca balls forming tight and compact massive clusters, making it impossible for the tapioca balls to be evenly distributed when added to beverages, thereby deteriorating the taste and flavor of the tapioca balls.

### SUMMARY OF THE INVENTION

The primary objective of the present invention is to provide a manufacturing method for ready-to-eat tapioca balls, and a structure thereof, in order to make the production of tapioca balls faster and to allow the tapioca balls so produced to be eaten immediately or to be preserved in a frozen state for easily making various pearl drinks.

The above-described manufacturing method for ready-to-eat tapioca balls is such that materials, such as glutinous rice flour, modified starch, water, and maltose, are mixed with granulated sugar, brown sugar, matcha, or a fruit additive of strawberry, mango, or pineapple, and then pressed into a base material in the form of block. The base material is steamed and cooked and then extruded by means of a forming apparatus into a round bar-shaped blank having an appropriate diameter. The round bar-shaped blank is cut into a segmented blank having an appropriate size. The segmented blank is kneaded into a tapioca ball semi-finished product in a spherical shape. During the processes of cutting and kneading, the tapioca ball semi-finished product is coated with powder to prevent sticking to each other. As such, tapioca balls of various flavors are thus completed. The tapioca balls can be manufactured faster and are ready to eat and can be used for making various pearl drinks convenient, and can be preserved in a frozen state.

In the above-described manufacturing method for ready-to-eat tapioca balls, different formulas are taken for normal temperature preservation and frozen preservation, wherein the materials of the normal temperature preservation formula include 13-15% of glutinous rice flour, 4-6% of modified starch, 14-16% of water, 49-51% of maltose, and 15-7% of an additive of granulated sugar.

In the above-described manufacturing method for ready-to-eat tapioca balls, different formulas are taken for normal temperature preservation and frozen preservation, wherein the materials of the frozen preservation formula include 4-6% of glutinous rice flour, 13-15% of modified starch, 14-16% of water, 49-51% of maltose, and 15-7% of an additive of granulated sugar.

In the above-described manufacturing method for ready-to-eat tapioca balls, in addition to granulated sugar that an original flavor, the additives can be 15-7% of brown sugar, matcha, or fruit additives, such as strawberry, mango, pineapple, durian, and passion fruit, which form other different flavors.

In the above-described manufacturing method for ready-to-eat tapioca balls, the tapioca ball of the normal temperature preservation formula can be added to baked bread, pizza or other baked food products, while the tapioca ball of the frozen preservation formula can be used to make ice bars and ice cream, or can be added to various tea drinks such as milk tea, fruit tea, matcha, or Thai milk tea, or cold drinks such as coffee.

The structure of above-described tapioca ball includes a solid body, and the solid body is a mass of solidified body formed by mixing and kneading materials such as glutinous rice flour, modified starch, maltose, and granulated sugar; and at least one additive, which comprises brown sugar, matcha, or fruit additives such as strawberry, mango, and pineapple, the additives being evenly mixed in the structure of the solid body in a predetermined ratio.

### BRIEF DESCRIPTION OF THE DRAWINGS

FIG. 1 is a flow chart illustrating a process of manufacturing according to the present invention.

FIG. 2 is a schematic view showing a forming apparatus according to the present invention.

FIG. 3 is a schematic view illustrating operation of the forming apparatus according to the present invention.

FIG. 4 is a perspective view showing the present invention.

FIG. 5 is a schematic view showing a packaged state of the present invention.

FIG. 6 is a schematic view illustrating a state of use of the present invention.

### DETAILED DESCRIPTION OF THE PREFERRED EMBODIMENTS

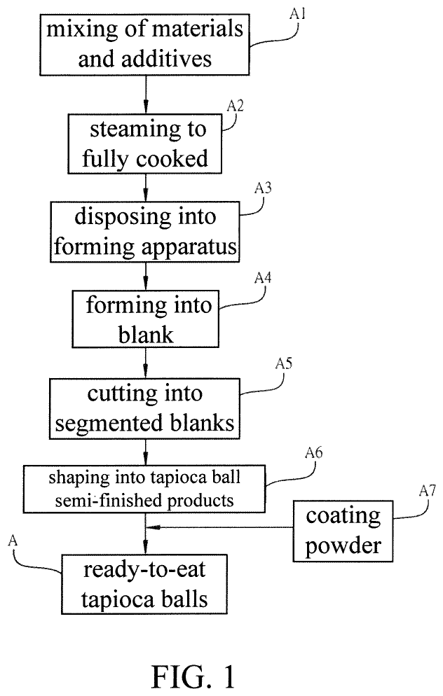

Referring to FIG. 1, which is a flow chart illustrating a process of manufacturing according to the present invention, as shown in the drawings, the manufacturing process according to the present invention comprises:
(1) mixing of materials and additives, A1, in which materials and additives are mixed and are divided into different formulas according to normal temperature preservation and frozen preservation, wherein materials of the normal temperature preservation formula include 13-15% of glutinous rice flour, 4-6% of modified starch, 14-16% of water, 49-51% of maltose, and 15-7% of an additive of granulated sugar, and materials of the frozen preservation formula include 4-6% of glutinous rice flour, 13-15% of modified starch, 14-16% of water, 49-51% of maltose, and 15-7% of an additive of granulated sugar,

wherein the aforementioned additives, in addition to granulated sugar that forms an original flavor, can alternatively be 15-7% of brown sugar, matcha, coffee, or fruit additives, such as strawberry, mango, pineapple, durian, and passion fruit, which form other different flavors;
(2) steaming to fully cooked, A2, in which the materials and additives mixed in Step (1) are steamed and fully cooked at an appropriate temperature and time to form a viscous base material;
(3) disposing into forming apparatus, A3, in which the steamed and fully cooked base material of Step (2) is disposed into a forming apparatus;
(4) forming into blank, A4, in which the steamed and fully cooked base material is extruded into a round bar-shaped blank by using the forming apparatus of Step (3);

(5) cutting into segmented blanks, A5, in which the round bar-shaped blank of Step (4) is cut into segmented blanks of an appropriate length;
(6) shaping into tapioca ball semi-finished products, A6, in which the segmented blanks of Step (5) are kneaded into tapioca ball semi-finished products that are of a spherical shape having an appropriate diameter;
(7) coating powder, A7, during processes of cutting and kneading in Steps (5) and (6), subjecting the segmented blanks and the tapioca ball semi-finished products to coating of powder to prevent sticking to each other, wherein in the instant embodiment, potato flour is used as the powder; and
(8) completing solid bodies of ready-to-eat tapioca balls having different flavors.

The present invention as described above, in addition to making production of tapioca ball faster, is ready to eat and makes preparation of various tapioca ball or pearl drinks convenient, and can be preserved in a frozen form.

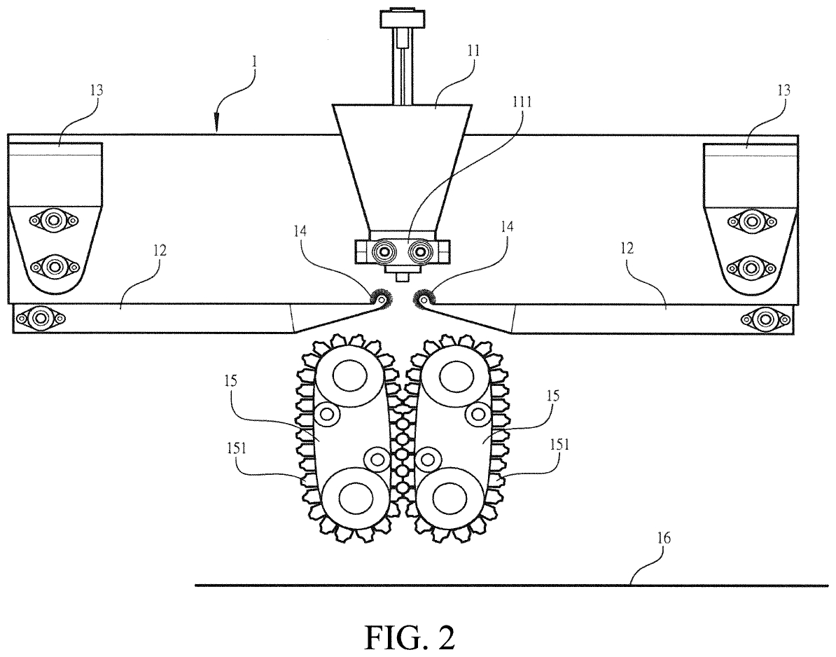

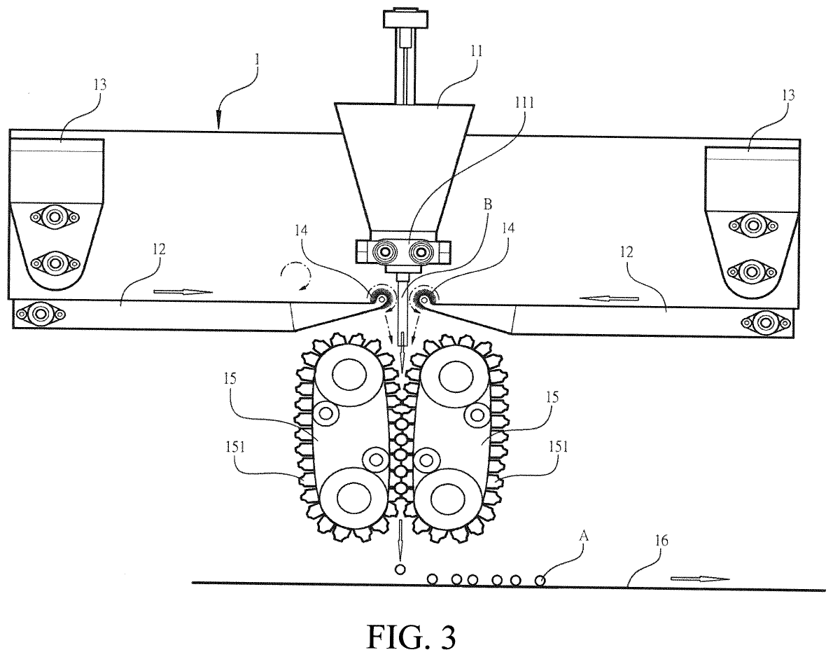

Referring to FIGS. 2 and 3, a schematic view of a forming apparatus according to the present invention and a schematic view illustrating operation of the forming apparatus are provided. Additional reference being had to FIG. 1, as shown in the drawings, the forming process according to the present invention is such that a forming apparatus 1 is set up. The forming apparatus 1 comprises a first receiving tank 11 for receiving and holding a base material. A forming unit 111 is arranged on a bottom of the first receiving tank 11. First conveyor belts 12, which are respectively provided on two sides below the first receiving tank 11, are arranged side by side and corresponding to each other for performing operation of inward transmitting, and second receiving tanks 13 are respectively provided above outer ends of the first conveyor belts 12 for receiving and holding powder (potato flour), while inner ends of the conveyor belts 12 are respectively provided with rotatable brushes 14 mounted thereon. Two rollers 15, which are symmetrically arranged, are set below the conveyor belts 12 to correspond, in position, to the first receiving tank 11, in such a way that lower ends of the two rollers 15 are inclined inward to make a gap between the two rollers 15 in a state of being wider at top and narrower at bottom. The two rollers 15 are each provided with a plurality of convex portions 151 on a roller surface thereof, and a second conveyor belt 16 is provided below the two rollers 15. With such an arrangement, a forming operation according to the present invention includes the following steps:
(1) The base material is disposed into the first receiving tank 11 to be extruded into a round bar-shaped blank by means of the forming unit 111 of the first receiving tank 11 and falling down from an outlet opening of the forming unit 111, wherein in the instant embodiment, the forming unit 111 may be provided with a plurality of outlet openings, which allow a plurality of round bar-shaped blanks B to simultaneously fall down therefrom;
(2) The plurality of round bar-shaped blanks B fall down into the gap between the two rollers, so as to be cut jointly by the relative rotation of the two rollers 15 and each of the convex portions 151 to define segmented blanks of an appropriate length on an upper side of the two rollers;
(3) A kneading operation is performed through the rotation and frontward and backward transverse movement of the two rollers 15, so that the segment blanks are kneaded into tapioca ball semi-finished products that are of a spherical shape on a lower side of the two rollers 15;
(4) During processes of cutting into segment blanks and kneading into tapioca ball semi-finished products, the powder of the second receiving tanks 13 is continuously spilled on the conveyor belts 12 so that the conveyor belts 12 convey the powder toward a center position and the powder is scattered by the rotating brushes 14 onto the site between the two rollers 15 to spread on the spherical shapes of the tapioca ball semi-finished products formed through kneading the segmented blanks so as to coat the tapioca ball semi-finished products with the powder to prevent sticking to each other to thereby form ready-to-eat tapioca balls A; and
(5) Products of powder-coated ready-to-eat tapioca balls A fall down onto the second conveyor belt 16 from between the two rollers 15 and are conveyed by the second conveyor belt 16 to a terminal site for packaging.

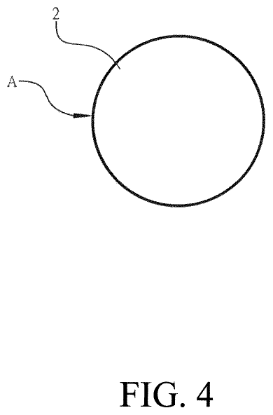

Referring to FIG. 4, which is a perspective view showing the present invention, as shown in the drawing, the spheres completed in the present invention are the ready-to-eat tapioca balls A, which include a spherical solid body 2. The solid body 2 is a spherical solidified body formed by mixing and kneading materials such as glutinous rice flour, modified starch, maltose, and granulated sugar with brown sugar, matcha, or fruit additives such as strawberry, mango, and pineapple; and the additives are evenly mixed in the structure of the solid body 2 in a predetermined ratio to form a spherical shape, which is the ready-to-eat tapioca ball A.

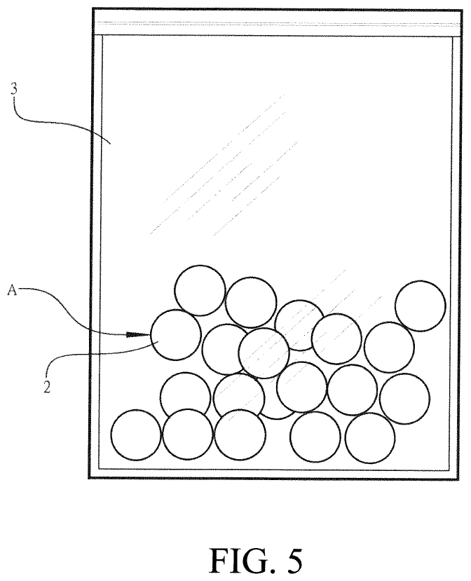

Referring to FIG. 5, which is a schematic view showing a packaged state of the present invention, as shown in the drawing, in the present invention, after the tapioca balls A are completed, an appropriate amount of the ready-to-eat tapioca balls A can be packaged in a packaging bag 3 for later use, wherein the ready-to-eat tapioca balls A, which are of the normal temperature preservation formula, can be added to baked bread, pizza or other baked food products. The tapioca balls A of the frozen preservation formula can be used to make ice bars and ice cream, or can be added to various tea drinks such as milk tea, fruit tea, matcha, or Thai milk tea, or cold drinks such as coffee and milk.

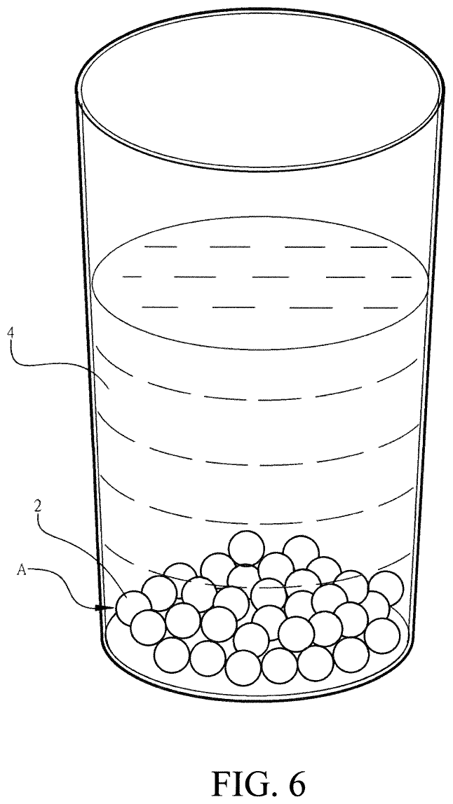

Referring to FIG. 6, which is a schematic view illustrating a state of use of the present invention, as shown in the drawing, in use of the present invention, the ready-to-eat tapioca balls A of the normal temperature preservation formula can be added to baked bread, pizza or other baked food products. The ready-to-eat tapioca balls A of the frozen preservation formula can be taken out from a freezer and washed to remove the coating powder attached to the surface thereof, and then soaked in sugar water to prevent them from sticking to each other, and as such, the ready-to-eat tapioca balls A soaked in sugar water can be taken out when selling, and added to various tea drinks such as milk tea, fruit tea, matcha or Thai milk tea, or cold drinks 4 such as coffee. As such, making tea drinks, such as pearl milk tea, is more convenient.

The foregoing embodiments are only for illustrating the preferred way of implementation of the present invention, and are not intended to limit the scope of the present invention. Minor modifications and changes may be made without losing the gist of the present invention, nor will it deviate from the spirit and scope of the present invention.

To sum up, the present invention uses solid bodies such as glutinous rice flour and modified starch, and uniformly mixes different flavor additives in the solid bodies in a predetermined ratio to form a tapioca ball structure, so that the tapioca balls can be supplied as being ready to eat and can be preserved favorably, and can be easily made into various pearl drinks for eating.

I claim:

1. A method for manufacturing ready-to-eat tapioca ball, comprising:
mixing materials and additives, which are divided into different formulas according to normal temperature preservation and frozen preservation, wherein the formula of normal temperature preservation comprises 13-15% of glutinous rice flour, 4-6% of modified starch, 14-16% of water, 49-51% of maltose, and 15-7% of an additive of granulated sugar; and the formula of frozen preservation comprises 4-6% of glutinous rice flour, 13-15% of modified starch, 14-16% of water, 49-51% of maltose, and 15-7% of an additive of granulated sugar;
extruding the mixed materials and additives into a round bar-shaped blank;
cutting the round bar-shaped blank into a segmented blank, which is subjected to coating of powder; and
kneading the segmented blank into a tapioca ball semi-finished product in a spherical shape, which is subjected to coating of powder to form a ready-to-eat tapioca ball.

2. The method for manufacturing ready-to-eat tapioca ball according to claim 1, wherein the additives comprise 15-7% brown sugar to form a different flavor.

3. The method for manufacturing ready-to-eat tapioca ball according to claim 1, wherein the additives comprise 15-7% matcha or coffee to form a different flavor.

4. The method for manufacturing ready-to-eat tapioca ball according to claim 1, wherein the additives comprise 15-7% fruit additive to form a different flavor.

5. A ready-to-eat tapioca ball structure, comprising a solid body, the solid body comprising a spherical solidified body formed by mixing and kneading materials of glutinous rice flour, modified starch, maltose, and granulated sugar; and at least one additive, which is made of at least one of brown sugar, matcha, and fruits of strawberry, mango, and pineapple, the at least one additive being uniformly mixed in a structure of the solid body in a predetermined ratio.
